(19) United States
(12) Patent Application Publication
(10) Pub. No.: US 2006/0064546 A1
(43) Pub. Date: Mar. 23, 2006

(54) Microprocessor

(76) Inventors: Hiroshi Arita, Hitachi (JP); Yasuhiro Nakatsuka, Tokai (JP); Koutaro Shimamura, Hitachinaka (JP); Yasuwo Watanabe, Hitachiota (JP)

Correspondence Address: DICKSTEIN SHAPIRO MORIN & OSHINSKY LLP, 2101 L Street, NW, Washington, DC, 20037, US

(21) Appl. No.: 11/190,004

(22) Filed: Jul. 27, 2005

(30) Foreign Application Priority Data
Jul. 28, 2004 (JP) 2004-219563

(51) Int. Cl. G06F 12/00

(52) U.S. Cl. 711/130; 711/146

(57) ABSTRACT

[Problem] To provide a microprocessor in which the bottleneck due to data sharing during memory access when a CPU and a plurality of accelerators are operated in a linked up manner can be minimized, whereby enhanced multimedia processing performance can be achieved.

[Means for solving the problem] A multimedia microprocessor 1 includes a CPU 11 and accelerators 12 in which the CPU 11 and the accelerators 12 perform multimedia processing in a linked up manner. In order to prevent the bottleneck caused by data sharing during memory access between the CPU 11 and the accelerators 12 via a memory 2, an I/O dedicated cache 14 is provided in front of the memory 2 to which the CPU 11 and the accelerators 12 can commonly access. Data required for data sharing is stored in the I/O dedicated cache 14, whereby data sharing between the CPU 11 and the accelerators 12 can be performed at higher speed and the speed of multimedia processing can be increased.

### TECHNICAL FIELD

The present invention relates to a microprocessor, and particularly to a technology that can be effectively applied to a microprocessor in which, in addition to processing performed by a CPU, communications and multimedia processing are performed using auxiliary circuits such as accelerators.

### BACKGROUND ART

The inventors have analyzed microprocessors for performing multimedia processing, and the following is a summary of our analysis.

For example, in microprocessors that can perform multimedia processing, a plurality of accelerators are provided in addition to and in support of a CPU so as to enhance multimedia processing performance. The accelerators help to increase the efficiency and speed of multimedia processing by performing, using hardware, time-consuming processing that the CPU is not very good at and by working in cooperation with the CPU (in what will be hereafter referred to as data shared).

The CPU and the accelerators include a cache for preventing processing slowdown due to memory access waiting-time, or a so-called bottleneck. When the data in a memory is modified by another accelerator, the data in the cache is disposed of so as to eliminate incoherency between the data in the cache and the data in the memory. When the CPU accesses the same address once again, the data in the memory is read and stored in the cache such that correspondence between cache and memory, or cache coherency, can be maintained.

Thus, even when a cache is built inside the CPU or the accelerators, data shared between the CPU and the accelerators is performed by direct access to the memory without the benefit of cache.

Examples of the technology to enable access from the CPU or accelerators to a memory are disclosed in Patent Documents 1 and 2. Patent Document 1 discloses a technique that enables the accelerators to access a memory at high speed. Patent Document 2 discloses a technique that enables the CPU to access a memory at high speed.
[Patent Document 1] JP Patent Publication (Kokai) No. 11-161598 A (1999)
[Patent Document 2] JP Patent Publication (Kokai) No. 2001-216194 A

### DISCLOSURE OF THE INVENTION

### Problems to be Solved by the Invention

The inventors' analysis of the aforementioned type of microprocessors that can perform multimedia processing provided the following insights.

In recent years, as a result of the progress in semiconductor manufacturing technology, multimedia processing systems are fabricated using system LSIs, whereby a plurality of accelerators can be mounted on a single chip and the speed of accelerators themselves has been increased to levels comparable to the speed of CPUs.

As a result, memories are subject to increasing load and it has become an important issue how best to increase access rates. What is important in this connection is the rate at which the data in a memory is read, or the latency. While memory access throughput has been improved in SDRAMs and DDR-SDRAMs, overhead associated with the input of commands is large and, as a result, latency has dropped.

Therefore, when data shared is performed between a CPU and accelerators, the CPU must experience, in addition to the accelerator processing waiting-time, memory access waiting-time in which the CPU has to wait until the data processed by the accelerators is written in the memory and can be read by the CPU. In other words, the multimedia processing rates are limited by the memory, which is slower than the CPU or the accelerators. Furthermore, the increase in the level of integration achieved by the progress in semiconductor manufacturing technology has enabled a plurality of accelerators to be mounted on a single chip. As a result, the CPU becomes increasingly subject to the influence of the drop in processing speed as data shared takes place between the CPU and a plurality of accelerators.

It is therefore an object of the invention to provide a microprocessor capable of achieving enhanced multimedia processing performance by minimizing the bottleneck in memory access that is caused when a CPU and accelerators are operated in a linked up manner for data shared.

The above and other objects of the invention as well as novel features thereof will become apparent when the following description is taken in conjunction with the attached drawings.

### Means for Solving the Problems

The following is a brief description of representative aspects of the invention.

The invention is directed to a microprocessor comprising a CPU that is operated as a master and a plurality of accelerators that are operated as slaves, in which the CPU and the accelerators can access a memory. The invention has the following features.

In a microprocessor according to the invention, the data for which the CPU and the accelerators access the memory is comprised of shared data that is shared between the CPU and the accelerators and the rest of the data, which is a data main body. The microprocessor of the invention further includes an I/O dedicated cache that stores the shared data.

In the microprocessor of the invention, the I/O dedicated cache has the function of, when the CPU and the accelerators issue write access requests to the memory, determining whether or not the data regarding the write access requests should be stored. The accelerators further have the function of outputting storage requests to the cache for I/O data when write-accessing the memory. The I/O dedicated cache further has the function of determining, in response to storage requests that are outputted when the accelerators write-access the memory, whether or not the data outputted by the accelerators should be stored. The I/O dedicated cache has the function of, when the CPU and the accelerators write-access the memory, determining whether or not relevant data should be stored depending on the address outputted by the CPU and the accelerators.

Further, in accordance with the microprocessor of the invention, the I/O dedicated cache, in response to read access requests from the accelerators to the memory, has the function of outputting data regarding the read access requests if it has such data stored therein to the accelerators.

The microprocessor of the invention further includes a memory controller for controlling access from the CPU and the accelerators to the memory. Access requests from the CPU and the accelerators are prioritized, and the memory controller processes access requests from the CPU and the accelerators in accordance with the order of priority. The memory is comprised of an SDRAM or a DDR-SDRAM. The memory controller, in response to access requests from the CPU and the accelerators, has the function of allowing access to locations of the same row address in the same bank sequentially. The memory controller further has the function of maintaining memory access consistency by managing a dependency relation with regard to those of access requests from the CPU and the accelerators that are addressed to the same address location.

Further, in accordance with the microprocessor of the invention, the memory is provided outside the microprocessor. Alternatively, the memory is provided inside the microprocessor.

Specifically, the invention is directed to a microprocessor that includes a CPU and a plurality of accelerators in which the CPU and the accelerators are operated in a linked up manner so as to perform multimedia processing. In order to prevent the bottleneck caused by data shared between the CPU and the accelerators via a memory, an I/O dedicated cache is provided in front of the memory which the CPU and the accelerators can commonly access. Data required for data shared is stored in the I/O dedicated cache, whereby data shared between the CPU and the accelerators can be performed at higher speed and the speed of multimedia processing can be increased.

Further, in accordance with the microprocessor of the invention, the CPU has an internal cache.

Further, in accordance with the microprocessor of the invention, the microprocessor is connected to an external memory in which a program area or a work area is formed. The external memory has a data area for the accelerators formed therein.

Further, in accordance with the microprocessor of the invention, the internal cache of the CPU has a snoop function.

### Effects of the Invention

Roughly speaking, the invention disclosed herein can, in its representative aspects, provide the following effect.

In accordance with the invention, it is possible to minimize the bottleneck caused by data shared during memory access when the CPU and the accelerators are operated in a linked up manner, whereby enhanced multimedia processing performance can be achieved.

### Best Modes for Carrying Out the Invention

Hereafter, embodiments of the invention will be described with reference to the drawings, in which like reference numerals identify similar or identical elements throughout the several views.

With reference to FIGS. 1 to 3, a multimedia microprocessor according to an embodiment of the invention and an example of its operation are described. FIG. 1 is a diagram of the multimedia microprocessor. FIG. 2 is a diagram of a memory. FIG. 3 is a diagram of another multimedia microprocessor.

As shown in FIG. 1, the multimedia microprocessor 1 of the present embodiment includes a CPU 11 that is operated as a master, a plurality of accelerators 12 (12-1 to 12-n) that are operated as slaves, an I/O dedicated cache 14 that is a feature of the invention, a bus 13 connecting the aforementioned units, and a memory controller 15. There is also a memory 2 connected outside the multimedia microprocessor 1.

The accelerators 12 have the function of aiding the CPU 11 and can perform, at high speed using hardware, such time-consuming processes that the CPU is not good at. The memory controller 15 is connected to the I/O dedicated cache 14 and the memory 2. It has the function of accessing the memory 2 by issuing an SDRAM or DDR-SDRAM command thereto in response to a memory access request that it receives via the bus 13 and the I/O dedicated cache 14.

As shown in FIG. 2, the memory 2 includes a program 21 describing a procedure relating to multimedia processings that are performed by the CPU 11, a work area 22, and a data area 23 (23-1 to 23-n) in which data processed by each of the accelerators 12 is stored. A particular data area 23 may be commonly accessed by a plurality of accelerators.

The multimedia microprocessor of the present embodiment may be modified into a multimedia microprocessor 1 shown in FIG. 3. In this application, a memory 2 is internally provided rather than externally as shown in FIG. 1, such that the memory 2 constitutes a part of an integral system comprised of the CPU 11, a plurality of accelerators 12 (12-1 to 12-n), I/O dedicated cache 14, bus 13, and memory controller 15.

The operation of the multimedia microprocessor 1 shown in FIG. 1 when the I/O dedicated cache 14 is off is described. The same description also applies to the multimedia microprocessor 10 shown in FIG. 3.

The CPU 11 performs processing by accessing the program 21 and the data in the work area 22 and data area 23 in the memory 2 via the bus 13, I/O dedicated cache 14, and memory controller 15. The CPU 11 performs multimedia processing involving MPEG or MP3, for example, by setting data to be processed by the accelerators 12 in the data area 23, issuing a processing request to the accelerators 12, and then reading from the data area 23 the result of processing by the accelerators 12, in accordance with the program 21.

Thus, in the multimedia microprocessor 1, data shared takes place between the CPU 11 and the accelerators 12 via the data area 23 in the memory 2 when multimedia processing is performed. As a result, the memory 2, whose accessing speed is slower than the processing speed of the CPU 11 and the accelerators 12, poses a bottleneck in multimedia processing, making it difficult to enhance multimedia processing performance. In accordance with the present embodiment of the invention, data is exchanged smoothly between the CPU 11 and the accelerators 12 so that multimedia processing can be performed at greater speeds, as will be described later.

Specifically, as shown in FIG. 1, the I/O dedicated cache 14 is placed towards the memory controller 15 so that it can be accessed by both the CPU 11 and the accelerators 12, where shared data between the CPU 11 and the accelerators 12 is stored in the cache. In this way, data shared between the CPU 11 and the accelerators 12 can be performed by the I/O dedicated cache 14, which is accessible at greater speeds, whereby the overhead due to memory access waiting-time can be significantly reduced and multimedia processing can be performed smoothly.

Not all of the data processed by the accelerators 12 is required for data sharing between the CPU 11 and the accelerators 12, but just some of the data, such as headers and commands to the accelerators 12 is required for data sharing. In view of this fact, the I/O dedicated cache 14 only stores shared data required for linkage purposes. Data main body, which is the data to be processed by either the CPU 11 or the accelerators 12 alone, is stored in the memory 2 instead of the I/O dedicated cache 14. In this way, the amount of data stored in the I/O dedicated cache 14 can be reduced, whereby the I/O dedicated cache 14 can be utilized more effectively and the hit ratio can be increased.

It should be noted that the shared data to be stored in the I/O dedicated cache 14 is invariably data that is written into the memory 2 by either the CPU 11 or the accelerators 12. Therefore, the I/O dedicated cache 14 needs to determine whether or not data is to be cached only with respect to write accesses to the memory 2. There are two methods for making such a determination, one involving the use of the address of a write access and the other involving the use of a cache request signal to the I/O dedicated cache 14. For the cache determination during a write access from the CPU 11, the method involving address may be used. For the cache determination during write access from the accelerators 12, both the method involving address and the method involving a cache request signal may be used.

With regard to a read to the memory 2, relevant data is outputted from the I/O dedicated cache 14 if there is a hit. In the event of a cache miss, the I/O dedicated cache 14 only allows access to the memory 2 without caching the read data from the memory 2. This is due to the fact that the CPU 11 and the accelerators 12 have a dedicated cache or buffer by which the read data from the memory 2 can be stored. In order to accommodate the case where the bus 13 is a split bus, the I/O dedicated cache 14 needs to be capable of outputting relevant hit data to the bus 13 in case of cache hit with respect to a next access request even when the memory 2 is being accessed for a read following a cache miss. The I/O dedicated cache 14 differs from conventional caches and buffers in this respect.

Another feature is that because the I/O dedicated cache 14 is a cache, access to the memory 2 can be processed without the program 21 executed by the CPU 11 being aware of the presence of the I/O dedicated cache 14.

Furthermore, in order to improve the efficiency of access to the memory 2, when the access size requested by the CPU 11 or the accelerators 12 is smaller than the access size of the memory 2, multiple access requests are bundled together in the I/O dedicated cache 14 before allowing them access to the memory 2 at once. In this way, the number of times of access to the memory 2 can be reduced, whereby the bottleneck due to memory access waiting-time can be reduced.

With reference to FIG. 4, an example of the flow of multimedia processing executed by the multimedia microprocessor is described. FIG. 4 shows the flow of the multimedia processing.

As shown in FIG. 4, the multimedia microprocessor 1 performs multimedia processing with the CPU 11 and the accelerators 12 operated in a linked up manner. The multimedia processing can be divided into a processing (1000) that is executed by the CPU 11, and a processing (1100) that is executed by the accelerators 12. The multimedia processing executed by the CPU 11 consists of a preprocessing (1001) and a postprocessing (1009). They are performed before and after the processing (1005) executed by the accelerators 12.

As the CPU 11 performs the preprocessing (1001), the CPU 11 writes relevant data in the data area 23 (1002) in order to pass the data to the accelerators 12, and then issues a activation request to the accelerators 12 (1003). In response, the accelerators 12 read the data from the data area 23 (1004), process the data (1005), and write the processing result back into the data area 23 (1006). Thereafter, the accelerators 12 send a processing completion report up to the CPU 11 (1007). Upon receiving the processing completion report from the accelerators 12, the CPU 11 reads the processing result from the data area 23 (1008) and then performs postprocessing (1009). Depending on the processed contents, some processings might be started from the accelerators 12 without any preprocessing (1001), or some processings might be completed by the accelerators 12 without any postprocessing (1009).

Thus, the CPU 11 and the accelerators 12 perform data sharing via the data area 23 when performing a multimedia processing.

With reference to FIGS. 5 and 6, an example of the flow of data in the multimedia processing using the I/O dedicated cache shown in FIG. 4 is described. FIGS. 5 and 6 show the flow of data in the multimedia processing. FIG. 5 shows the processing from preprocessing (1001) to the accelerator processing (1005) shown in FIG. 4. FIG. 6 shows the processing from the setting of the processing result (1006) to postprocessing (1009).

As shown in FIG. 5, the CPU 11 first performs preprocessing (1001) and then writes resultant data in the data area 23 so that the data can be processed by the accelerators 12 (1002, 101). The I/O dedicated cache 14 caches the write data to the data area 23 from the CPU 11 and writes the data in the data area 23 in the memory 2 (102). The I/O dedicated cache 14 determines whether or not the data is to be cached depending on whether or not the data is addressed to the data area 23 based on the write address that is outputted by the CPU 11 together with the write data.

Thereafter, the CPU 11 outputs an activation request signal to the accelerators 12 (1003). In response, the accelerators 12 start up and reads the relevant data from the data area 23 (1004). The shared data, which is a portion of the written data that is cached on the I/O dedicated cache 14, is read from the I/O dedicated cache 14 (103), while the data main body, which is not cached on the I/O dedicated cache 14, is read directly from the data area 23 of the memory 2 (104). The accelerators 12, then process the thus read data (1005).

As shown in FIG. 6, after the accelerators 12 complete processing (1005), they write the processing result back into the data area 23 (1006, 111). At the same time, the I/O dedicated cache 14 caches the write data from the accelerators 12 to the data area 23, and also writes the processed data in the data area 23 of the memory 2 (112). The I/O dedicated cache 14 determines whether or not the data is to be cached depending on the cache request signal or the write address that is outputted from the accelerators 12 together with the processed data.

Upon reception of the processing completion report from the accelerators 12 (1007), the CPU 11 reads the processed data from the data area 23 (1008). Because the data to be processed by the CPU 11 is the shared data, which is a portion of the processed data that is cached on the I/O dedicated cache 14, the CPU 11 can perform postprocessing (1009) simply by reading from the I/O dedicated cache 14 (113). The CPU 11 reads from the data area 23 of the memory 2 only when there is some data that has not been cached due to the capacity of the I/O dedicated cache 14 (114).

Thus, the CPU 11 and the accelerators 12 carry out data sharing via the I/O dedicated cache 14, which has a shorter access latency and is faster than the memory 2. In this way, the access waiting-time that causes overhead can be significantly reduced as compared with the case of data sharing via the data area 23 of the memory 2. As a result, the multimedia processing can be performed at higher speeds.

When the CPU 11 performs postprocessing, it is not often that the CPU 11 reads all of the data processed by the accelerators 12. In view of this fact, when the relevant processed data is written into the memory 2, the shared data, which is the data portion read by the CPU 11, is cached in the I/O dedicated cache 14, and the remaining data main body is written directly into the data area 23 of the memory 2 without caching it in the I/O dedicated cache 14.

When the accelerators 12 perform a processing, they access the data area 23 basically with reference to sequential addresses. Therefore, in view of the fact that the memory 2 is comprised of a memory with a high-speed throughput, such as SDRAM or DDR-SDRAM, only the initial portion of the data area 23 is stored in the I/O dedicated cache 14 and the rest is left up to the sequential accessing performance of the memory 2.

In this way, the shared data portion that is cached on the I/O dedicated cache can be reduced, whereby the I/O dedicated cache 14 can be effectively utilized.

With reference to FIGS. 7 to 14, the structure and operation of an I/O dedicated cache is described in detail. FIG. 7 shows the structure of a bus. FIG. 8 shows the structure of an I/O dedicated cache. FIG. 9 shows the structure of registers. FIGS. 10(a) and (b) shows the register access paths in the cache for I/O data. FIG. 11 shows the flow of the processing performed by a judgment circuit. FIG. 12 shows the structure of an address judgment circuit. FIG. 13 shows the structure of the cache for I/O data. FIG. 14 shows the operation of the cache for I/O data.

As shown in FIG. 7, the bus 13 is comprised of an address bus 131 and a data bus 132. The address bus 131 is comprised of an address 1311 of an access destination, an access signal 1312, and a cache request signal 1313 from the accelerators 12. The data bus 132 is comprised of a read data bus 1321 and a write data bus 1322.

As shown in FIG. 8, the I/O dedicated cache 14 is connected to the bus 13 and the memory controller 15 and is comprised of registers 141, a judgment circuit 142, and a cache 143. The judgment circuit 142 outputs a cache request 144 to the cache 143, while the registers 141 outputs an area register data signal 145 to the judgment circuit 142. In the I/O dedicated cache 14, the address bus 131 is connected to the judgment circuit 142 and the cache 143. The data bus 132 is connected to the cache 143.

As shown in FIG. 9, the registers 141 is accessible from the CPU 11 and is comprised of a plurality of registers that store the state of the I/O dedicated cache 14 and setting values thereof. Specifically, the registers 141 is comprised of: an operation mode register 1411 for setting the valid or invalid state of the I/O dedicated cache 14; a cache mode register 1412 for defining the operation mode of the cache 143, such as a write-back mode or a write-through mode; and shared data-area registers 1413 for designating a data area (address range) to be provided in the I/O dedicated cache 14.

In the shared data-area registers 1413, each shared data area is represented by a shared data-area address register 1414 (1414-1 to 1414-m) and a shared data-area mask register 1415 (1415-1 to 1415-m). By thus providing a plurality of sets of such two registers, a plurality of shared data areas can be supported. The shared data-area mask register 1415 represents bits to be compared when values are compared between the shared data-area address register 1414 and address 1311. In this way, the shared data area can be represented by the two registers 1414 and 1415. Alternatively, the shared data area can be represented by a set of a shared data-area start address register and a shared data-area end address register.

These register values in the shared data-area registers 1413 are outputted to the judgment circuit 142 in the form of an area register data signal 145.

With regard to the access path from the CPU 11 to the registers 141, there is a configuration (a) in which the registers 141 are connected to the bus 13, and another configuration (b) in which the registers 141 is connected to the bus 13 via a register access bus that is different from the bus 13, as shown in FIG. 10. In the configuration shown in FIG. 10(a), the registers 141 are connected to the bus 13 via which the CPU 11 accesses the register. On the other hand, in the configuration shown in FIG. 10(b), the registers 141 are connected to the bus 13 via the register access bus via which the CPU 11 accesses the registers 141.

In response to a write access from the CPU 11 and the accelerators 12 to the memory 2, the judgment circuit 142 determines whether or not the write data should be stored in the cache 143 on the basis of the area register data signal 145 from the registers 141, the address bus 131, and the cache request signal 1313 from the accelerators 12. After the determination, the judgment circuit outputs a cache request 144 to the cache 143. A method for such determination is shown in FIG. 11.

As shown in FIG. 11, in response to the access request to the memory 2 via the bus 13, the judgment circuit 142 first checks the access signal 1312 to determine the type of access (1421). If it is a read access, the judgment circuit 142 deems the cache request 144 invalid (1426).

If it is determined at 1421 that the access is a write access, it is examined whether or not the address 1311 of the write access is in the shared data area based on the area data register signal 145 from the registers 141 as well as the address 1311 (1422). If it is in the shared data area (Yes), the cache request 144 is deemed valid (1425).

If it is determined at 1422 that the address is outside the shared data area (No), the source of the write access request is determined (1423), and if it is a write access from the CPU 11, the cache request 144 is deemed invalid (1426).

If it is determined at 1423 that the access request source is the accelerators 12, it is examined whether or not the cache request signal 1313 from the accelerators 12 is valid (1424). If valid, the cache request 144 is deemed valid (1425).

If it is determined at 1424 that the cache request signal 1313 from the accelerators 12 is invalid, the cache request 144 is deemed invalid (1426).

The aforementioned determination (1422) as to whether or not the address of the write access is in the shared data area is described with reference to FIG. 12.

As shown in FIG. 12, during the determination (1422), the address 1311 is compared with the addresses in the shared data-area address registers 1414-1 to 1414-m, using the area register data signal 145 from the registers 141 and the address 1311 as inputs. Gates 1425-1 to 1425-m calculate a logical product for each bit between the shared data-area address registers 1414-1 to 1414-m and the shared data-area mask registers 1415. Gates 1426-1 to 1426-m calculate a logical product for each bit between the address 1311 and the shared data-area mask registers 1415. Only those bits enabled by the aforementioned gates are entered into comparators 1427-1 to 1427-m. A total logical sum of the results of comparison by each of the comparators 1427-1 to 1427-m is calculated by a gate 1428 so as to determine whether or not the address 1311 is in the shared data area.

In this way, the judgment circuit 142 determines whether or not the access to the memory 2 is an access to the shared data area, and then outputs the cache request 144 to the cache 143. The cache 143, which is connected to the bus 13 and the memory controller 15 and which operates as a write-back or write-through cache, receives the cache request 144 from the judgment circuit 142 and caches the write data.

FIG. 13 shows the structure of the cache 143, which is of the full-associative cache and includes N entries, each of which stores address information, data, and control information. The size of data stored in each entry is approximately 32B or 64B, for example. The control information includes LRU information for the replacement of entry, valid bits indicating whether or not data is registered in the entry, and dirty bits (which are used during write-back) indicating whether or not the data has been updated. A cache hit refers to an instance where the relevant address is registered in the entries of the cache 143. A cache miss refers to an instance where the relevant address is not registered in the cache 143.

The operation of the cache 143 can be classified into the following five kinds (three kinds (a)-(1), (2), and (3) for write access; two kinds (b) and (c) for read access):

(a)-(1) When the access is a write access, the cache request 144 is valid, and there is a cache hit, the data in the relevant entry registered in the cache 143 is overwritten with the write data on the data write bus 133, and the dirty bit is turned on.

(a)-(2) When the access is a write access, the cache request 144 is valid, and there is a cache miss and an invalid entry in the cache 143, the vacant entry in the cache 143 is searched for and the write data is registered in that entry. Specifically, the entry is rendered valid, and the value of the address 1311 is written in the address information. If the size of the write data from the data write bus 1322 is smaller than the data size of the entry, the write data is written after the contents data in the address is read from the memory 2 and registered in the data information in the entry.

(a)-(3) When the access is a write access, the cache request 144 is valid, and there is a cache miss and no vacant entry in the cache 143, the LRU information that is present in the control information in each entry in the cache 143 is examined and the oldest entry is discarded, and then the write data is registered in this entry. The registration procedure is the same as in (a)-(2).

(b) When the access is a read access and there is a hit in the cache 143, the data information in the entry of the relevant address that is registered in the cache 143 is outputted to the data read bus 1321.

(c) When the access is a read access and there is a miss in the cache 143, the relevant address is outputted to the memory controller 15, and the data corresponding to the relevant address is read from the memory 2 and is then outputted to the data read bus 1321. The thus read data is not registered in the cache 143.

When data is registered in the cache 143 during the above processing, if all of the entries are in use, an entry to be eliminated from the cache 143 is searched for using an algorithm such as LRU, as in conventional caches. If the cache 143 is in the write-back mode, the data in the relevant entry is written back to the memory 2.

By the above procedure, the I/O dedicated cache 14 stores the write data from the CPU 11 and the accelerators 12 in the cache 143, so that the data sharing between the CPU 11 and the accelerators 12 can be realized in the I/O dedicated cache 14. In this way, the bottleneck due to data sharing can be eliminated and the speed of multimedia processing can be increased. Furthermore, by having the I/O dedicated cache 14 store only such a portion of data that is actually linked up, the I/O dedicated cache 14 can be used more efficiently and the overhead due to cache miss can be minimized.

Furthermore, in order to increase the processing speed of the I/O dedicated cache 14 and to accommodate a split bus, the processing is pipelined and a three-stage system is adopted as shown in FIG. 14. With regard to an entry that is accessing the memory 2 due to a cache miss, access to the same entry is put on hold until the registration processing for the entry is completed, so that memory access is correctly carried out even during memory conflict.

Specifically, as shown in FIG. 14, in stage 1, the judgment circuit 142 makes a cache request determination, while the cache 143 makes a hit determination during write access and read access. In stage 2, during the operation of the cache, the data in the cache 143 is updated in case of a hit and the memory 2 is accessed in case of a miss when the access is a write access. When the access is a read access, the data is outputted from the cache 143 in case of a hit and the memory 2 is accessed in case of a miss. In stage 3, during the operation of the cache, data is registered in the cache 143 in case of a miss when the access is a write access, while data is outputted to the bus 13 in case of a miss when the access is a read access.

In this way, the judgment circuit 142 can make a cache request determination and the cache 143 can make a cache determination processing even when the memory is being accessed. As a result, the overhead due to the I/O dedicated cache 14 can be reduced.

Another application of the above embodiment in which the I/O dedicated cache 14 and the memory controller 15 are combined for achieving even higher efficiency is described in the following.

With reference to FIGS. 15 to 17, the application in which higher efficiency is achieved by combining the I/O dedicated cache 14 and the memory controller 15 is described. FIG. 15 shows the structure of the memory controller. FIG. 16 shows the structure of the cache. FIG. 17 shows the data structure of an access request.

The memory controller 15 is provided with the following functions:

(1) The concept of priority is introduced in memory access for ensuring memory bandwidth. Namely, memory access priority is given to an accelerator that requires a wide band.

(2) An out-of-order access is adopted so as to minimize the overhead of memory access. Namely, the active state is managed for each bank of the SDRAM and DDR-SDRAM, and the order of memory access is changed such that locations of the same-row address that can be accessed by simply entering CAS addresses to each bank can be accessed sequentially.

For a write access, although the CPU 11 or the accelerators 12 can move onto a next processing once the I/O dedicated cache 14 receives an access request, the CPU 11 or the accelerators 12 would have to experience memory access waiting if a read access is delayed. Therefore, more priority must be given to read access. Thus, in the present memory controller 15, only the speed of memory access is increased, and the priority-order control for band ensuring purposes is performed only for read access.

It should be noted that by ensuring the band or performing the out-of-order access, the order of access to the memory 2 is changed. Therefore, it is important to maintain memory consistency so that the same results can be obtained as when the memory is accessed in the access order. For the maintenance of memory consistency, the following considerations must be made.

There is no problem regarding the change of order with regard to two memory accesses to different address locations. With regard to two memory accesses to the same address location, there should be no change in the order beyond write access. Hereafter, when there are two such memory access requests to the same address location, it will be said that there is dependency relation between the two memory accesses.

FIG. 15 shows the structure of the memory controller 15. As shown in FIG. 15, the memory controller 15 is comprised of an access control circuit 151, a refresh control circuit 152, a prioritized read access request FIFO 153, a write access request FIFO 154, and a memory access control circuit 155. The read access request FIFO 153 includes individual FIFOs (153-1 to 153-n) for each order of priority.

FIG. 16 shows the structure of the cache 143 in the I/O dedicated cache 14. As shown in FIG. 16, in the cache 143, priority indicating the order of priority is registered, in addition to the address information, data, and control information stored in each of the N entries shown in FIG. 13.

In this application of the present embodiment, an access request with priority information attached thereto in accordance with the CPU 11 and the accelerators 12 is sent from the I/O dedicated cache 14. In response, the access control circuit 151 converts such a request into an access request format shown in FIG. 17. This format consists of access attributes regarding access requests and dependency relation information for maintaining memory consistency. The access attributes include the tagNo for managing each access, a read/write signal, address, and data. The dependency relation information consists of the tagNo of a memory access request with which the present access request has dependency relation, and a final bit indicating whether or not there is any access that depends on the present access request.

The access control circuit 151 operates in response to an access request from the I/O dedicated cache 14 as follows:

(1) In response to a new access request, a new tag is issued and registered in tagNo. Also, the final bit is set.

(2) Then, previous access requests that are queued in the read access request FIFO 153 and the write access request FIFO 154 are examined to determine whether or not there is any dependency relation. If there is no dependency relation, the access request is queued in a corresponding one of the read access request FIFOs 153-1 to 153-n in the case of a read access, or in the write access request FIFO 154 in the case of a write access, and the processing comes to an end.

If there is dependency relation, the following processing is performed:

(a)-(1) If the access request is a read access request, and if the preceding, latest access request (where the final bit is set) with which the present access request has dependency relation is a write access request, the write access data of the preceding access request is returned, and the processing ends without queuing the present read access request (FIFO hit).

(a)-(2) If the access request is a read access request, and if the preceding, latest access request (where the final bit is set) with which the present access request has dependency relation is a read access request, the tagNo of the preceding read access request is registered in the dependency tag of the present access request, and the final bit of the preceding read access request is cleared.

(b) If the access request to be queued is a write access, the tagNo of the preceding access request is registered in the dependency tag of the present access request, and then the final bit of the preceding write access request is cleared.

The memory access control circuit 155 operates such that, with regard to each of the read access request FIFOs 153 and the write access request FIFO 154, access requests are taken out in order of priority of the FIFOs. Regarding access issued to SDRAM, and for access to the same-bank and the same-row addresses, read accesses and write accesses are respectively bundled together when the memory 2 is accessed. In this case, those access requests in which the dependency tagNo is set are excluded and, for each access request to the memory 2, if the final bit is set, which indicate the absence of dependency relation, the processing comes to an end. If the final bit has been cleared, a dependency relation list is updated in accordance with the following procedure:
(a) For each access request that is queued, it is determined to see if the dependency tag corresponds to the tag number of the present access request that has been completed.

(b) For the access request that is being queued, the dependency tag is cleared.

In this way, it becomes possible to efficiently allow access to the locations of the same-row address in each bank of SDRAM and DDR-SDRAM while memory consistency is maintained. As a result, the efficiency of access to the memory 2 can be improved. Because of this improvement in access efficiency, together with the effect provided by the I/O dedicated cache 14, it becomes possible to perform multimedia processing smoothly while the bottleneck due to the memory 2 can be minimized.

With reference to FIG. 18, an example is described of a multimedia terminal utilizing the multimedia microprocessor of the present embodiment. FIG. 18 is a diagram of the multimedia terminal utilizing the multimedia microprocessor.

In recent years, multimedia terminals, such as cellular phones and PDAs that are equipped with small-sized displays, are becoming increasingly equipped with music-player function or camera function, whereby still images (photos) or moving pictures (movies) can be displayed.

A multimedia terminal 100 includes a multimedia microprocessor 1 as a core to which a memory 2, a display 3 that is an input/output unit, a camera 4, a speaker 5, and a communications unit 6 are connected.

The multimedia microprocessor 1 includes an interface connected with the display 3, camera 4, speaker 5, and communications unit 6. It also includes accelerators for display control, image input control, voice output control, and communications transmission/reception control. The interface and the accelerators allow images taken by the camera 4 to be displayed on the display 3 or allow pictures to be transmitted or received at high speed between the multimedia microprocessor 1 and the outside via the communications unit 6.

With reference to FIGS. 19 and 20, an example of the configuration and operation of another multimedia microprocessor according to the present embodiment is described. FIG. 19 shows a diagram of another multimedia microprocessor. FIG. 20 shows how the cache and the I/O dedicated cache are separately used.

As shown in FIG. 19, the multimedia microprocessor 1 includes a CPU 11 that operates as a master and that has an internal cache 110, a plurality of accelerators 12 (12-1 to 12-n) that operate as slaves, an I/O dedicated cache 14, which is a feature of the invention, a bus 13 for connecting these, and a memory controller 15. Outside the multimedia microprocessor 1, there is connected a memory 2 including a program 21 that describes a series of processings to be performed by the CPU 11, a work area 22, and a data area 23 (23-1 to 23-n) in which data to be processed by each of the accelerators 12 is stored.

The cache 110 and the I/O dedicated cache 14 have the function of a cache for temporarily storing the contents of the memory 2. The cache 110 enhances access efficiency when the CPU 11 accesses the memory 2. The I/O dedicated cache 14 enhances access efficiency when the CPU 11 and the accelerators 12 access the memory 2.

How the cache 110 and the I/O dedicated cache 14 are used separately is described with reference to FIG. 20. In the following, the cache 110 is assumed to be of the copy-back system, whereby access from the accelerators 12 to the memory 2 is monitored using a snoop function so as to maintain cache coherency between the cache 110, the memory 2, and the I/O dedicated cache 14. When the cache reads a line-size amount of data from the memory 2, this will be referred to as “feeding”. When the cache writes a line-size amount of data in the memory 2, this will be referred to as “purging”.

When the CPU 11 accesses the program 21 or the work area 22, the cache 110 alone is operated while the I/O dedicated cache 14 is passed through (121). Thus, in the event a cache miss occurs in the cache 110, the cache 110 feeds or purges data in the memory 2 during both read and write (write back) access from the CPU 11.

On the other hand, when the CPU 11 accesses the data area 23 in the accelerators 21, both the cache 110 and the I/O dedicated cache 14 are operated (122 to 124). Therefore, if a cache miss occurs in the cache 110, a cache determination is made also in the subsequent I/O dedicated cache 14.

When there is a cache hit in the I/O dedicated cache 14, the CPU 11 accesses the data on the I/O dedicated cache 14 (122). When there is a cache miss in the I/O dedicated cache 14, the operation of the I/O dedicated cache 14 differs depending on the type of access from the cache 110:

(1) Cache-feed access from the cache 110 (read):

The I/O dedicated cache 14 allows read data from the memory 2 to be passed through it and outputs the data to the cache 110 (123).

(2) Cache-purge access from the cache 110 (write):

(a) The I/O dedicated cache 14, when the relevant purge data is shared data, registers it in the I/O dedicated cache 14. If the line size of the cache 110 is smaller than the line size of the I/O dedicated cache 14, a line containing the relevant purge data is fed from the memory 2 (124), and then the purge data is written.

(b) When the relevant purge data is not shared data, the data is passed through the I/O dedicated cache 14 and written in the memory 2 (123).

Hereafter, an example of a multimedia microprocessor will be described with reference to FIGS. 21 to 28, in which high-speed communications are achieved by carrying out encryption on the IP protocol level and using an IPsec for ensuring security. The IPsec is defined as a standard protocol for VPN (Virtual Private Network).

FIG. 21 shows the configuration of a multimedia microprocessor 1, which includes a CPU 11, accelerators 12, an I/O dedicated cache 14, a bus 13 for connecting them, and a memory controller 15. The accelerators 12 include a TCP accelerator 12-1, an IPsec accelerator 12-2, and an EtherMAC 12-3. The TCP accelerator 12-1 is responsible for checksum calculation and memory copy. The IPsec accelerator 12-2 is responsible for decoding and authentification. The EtherMAC 12-3, which is connected via LAN 3, has the function of transmitting and receiving frames through the LAN. LAN 3 is comprised of Ethernet, which is the most widely used form of LAN.

FIG. 22 shows the frame structure when communications are performed using the transport base of IPsec. In the LAN and on the Internet, TCP/IP protocol is used as a standard protocol, whereby, if the data size to be transmitted or received is larger than the size that can be transmitted in a single frame, the data is divided into a plurality of TCP packets for transmission or reception.

As shown in FIG. 22, in the transport mode of IPsec, an IP header is attached to an IPsec packet in which a TCP packet is encrypted, thus achieving encapsulation using IP. Because Ethernet is used in the multimedia microprocessor 1 for LAN application, a MAC header is attached at the end. FIG. 23, meanwhile, shows the frame structure of the TCP/IP in a case where no IPsec is used.

The IPsec packet consists of an IPsec header and IPsec data. The IPsec header is comprised of an ESP header for encryption reasons. The IPsec data is comprised of a TCP packet to which an ESP trailer having data necessary for encryption is attached for overall encryption purposes. The IPsec data also includes an ESP authorization value for allowing the detection of falsification.

The operation of the cache is described hereafter with reference to a reception processing (FIG. 24) involving no use of the I/O dedicated cache, a reception processing (FIG. 25) involving use of the I/O dedicated cache, and a reception processing (FIG. 26) involving use of the I/O dedicated cache in which shared data alone is stored.

With reference to FIG. 24, a processing for receiving an Ethernet frame in the transport mode of the IPsec shown in FIG. 22 when the I/O dedicated cache 14 is not used is described.

(1) The multimedia microprocessor 1 receives a relevant Ethernet frame via Ethernet 3 and writes in a data area 23 of accelerators 12 in a memory 2 (1001, 1011).

(2) CPU 11 reads the MAC header and IP header of the relevant frame 1011 from the data area 23 of the accelerators 12 and then performs Ethernet reception and IP reception (1002).

(3) CPU 11, because the relevant Ethernet frame 1011 includes an IPsec packet, reads the IPsec header in the Ethernet frame 1011, performs an IPsec reception processing, and activates the IPsec accelerator 12-2.

(4) The IPsec accelerator 12-2 reads the IPsec data in the relevant Ethernet frame 1011 from the data area 23 of the accelerators 12, performs an authentication and decoding processing, and then writes the result back in the data area 23 of the accelerators 12 as a TCP packet 1012 (1003).

(5) CPU 11 reads the TCP header from the TCP packet 1012 in the data area 23 of the accelerators 12 and performs a reception processing, while it activates the TCP accelerator 12-1 for calculating the checksum (1004).

(6) The TCP accelerator 12-1 reads the TCP packet 1012 in the data area 23 of the accelerators 12 and calculates the checksum, while it writes the TCP data at an appropriate location (third from left in the figure) in the reception data (1005).

In this way, when the I/O dedicated cache 14 is not used, access to the memory 2 takes place five times for each Ethernet frame.

On the other hand, the operation when the I/O dedicated cache 14 is used is described with reference to FIG. 25.

(1′) The multimedia microprocessor 1 receives a relevant Ethernet frame via the Ethernet 3 and writes in the data area 23 in the accelerators 12 in the memory 2 (1021, 1011). However, because this is an instance of writing in the data area 23 of the accelerators 12, the I/O dedicated cache 14 caches the relevant frame (1011′) and no actual access to the memory 2 occurs.

(2′) CPU 11, when it reads the MAC header and the IP header in the frame 1011 in the data area 23 of the accelerators 12, comes up with a hit in the I/O dedicated cache 14. Therefore, the MAC header and the IP header of the relevant frame 1011′ are read from the I/O dedicated cache 14 without any access to the memory 2 taking place, and then Ethernet-reception and IP reception processing are performed (1022).

(3′) CPU 11, because the relevant Ethernet frame 1011′ includes an IPsec packet, reads the IPsec header in the Ethernet frame 1011, performs an IPsec reception processing, and activates the IPsec accelerator 12-2. Because this access to the memory 2 produces a hit in the I/O dedicated cache 14 as in the case of (2), the IPsec header of the relevant frame 1011′ is read and no access to the memory 2 takes place (1022).

(4′) While the IPsec accelerator 12-2 attempts to read the IPsec data in the relevant Ethernet frame 1011, a hit is produced in the I/O dedicated cache 14. Therefore, the IPsec data is actually read from the relevant Ethernet frame 1011′ (1023). Thereafter, the IPsec accelerator 12-2 performs an authentication and a decoding processing, and writes the result back in the data area 23 of the accelerators 12 as a TCP packet 1012. However, because this is an instance of writing in the data area 23 of the accelerators 12, the I/O dedicated cache 14 caches the data (1012′) and no actual access to the memory 2 takes place (1023).

(5′) While CPU 11 attempts to read the TCP header from the TCP packet 1012 in the data area 23 of the accelerators 12, a hit is actually produced in the I/O dedicated cache 14. Therefore, actually the TCP header of the TCP packet 1012′ is read (1024). Thereafter, the CPU 11 performs a TCP reception processing and, in order to calculate a checksum, activates the TCP accelerator 12-1.

(6′) While the TCP accelerator 12-1 attempts to read the TCP packet 1012 in the data area 23 of the accelerators 12, a hit is produced in the I/O dedicated cache 14. Therefore, a TCP packet 1012′ is read. The TCP accelerator 12-1 calculates a checksum while it writes the TCP data at an appropriate location in the reception data (1025).

Thus, by storing the shared data that both the accelerators 12 and the CPU 11 access in the I/O dedicated cache 14, the number of times of access to the memory 2 can be made zero. In reality, data is divided into a plurality of Ethernet frames for transmission or reception in the case of images or downloads, the overhead of access to the memory 2 significantly affects communications performance.

The shared data that both the CPU 11 and the accelerators 12 access is comprised of the header portions 1031 and 1032. Because the I/O dedicated cache 14 caches such shared data, the CPU 11 can read the data written by the accelerators 12 not from the memory 2, which has slower access speed, but from the I/O dedicated cache 14. As a result, access waiting-time, which creates overhead, can be significantly reduced, and it becomes possible to perform the TCP/IP communications on the IPsec basis at high speed.

FIG. 26 shows an example in which the shared data portions 1031 (MAC header, IP header, and IPsec header) and 1032 (TCP header) alone are stored in the I/O dedicated cache 14 while other data (IPsec data and TCP data) is stored in the memory 2. This example shows a case when a plurality of accelerators 12 are operated simultaneously and there is no excess capacity in the I/O dedicated cache 14.

On the other hand, when there is excess capacity in the I/O dedicated cache 14, as shown in FIG. 25, data other than the shared data portions 1031 and 1032 is also cached, whereby it becomes possible to utilize the I/O dedicated cache for data transfer between accelerators 12. On the side of the accelerators 12, access is often made with reference to sequential addresses. In view of this fact, it is important that the shared data 1031 and 1032 would not be cached out by the data transfer between the accelerators 12. The shared data can be preferentially cached on the I/O dedicated cache 14 by the following methods, for example:

(a) Cache the shared data alone.

(b) Extend the duration of time in which the shared data stays cached as compared with other data (by reducing the rate of progress of the LRU counter as compared with other data, for example).

(c) Provide an in-use bit for the shared data in each line, and clear the in-use bit after a sequence of processing is completed in the CPU 11. The cleared lines become subject to cache-out.

Because the methods (a) and (b) would be implemented in the I/O dedicated cache 14, they do not require any intervening application software. The method (c), however, would require the in-use bit to be managed on the OS or driver/middle-ware level.

These methods would allow the shared data to stay in the I/O dedicated cache 14 for a longer time, so that it becomes possible to prevent performance degradation caused by the caching of the shared data out of the I/O dedicated cache 14, particularly when multiple accelerators are simultaneously operated.

FIG. 27 shows a processing for transmitting data that has been encrypted, by means of IPsec. A transmission processing is carried out oppositely from the reception processing.

The CPU 11 sets transmission data in the data area 23 of the accelerators 12 in the memory 2. The writing of the transmission data in the data area 23 of the accelerators 12 is detected by the I/O dedicated cache 14, which caches the data. In the example shown in FIG. 27, the transmission data is divided into four frames, of which the third data 1061 is transmitted.

(1) CPU 11 activates the TCP accelerator 12-1 so as to transmit the third data 1061.

(2) The TCP accelerator 12-1 cuts the transmission data in the data area 23 of the accelerators 12 to a size 1061 that can be transmitted using a single frame, calculates a checksum, and copies the data in a TCP data portion of a transmit buffer 1062. Because the TCP accelerator 12-1 accesses the data area 23 of the accelerators 12, actually 1061′ in the I/O dedicated cache 14 is read and written in a TCP data portion of 1062′ (1051).

(3) CPU 11 creates a TCP header and writes it in the TCP header in the TCP packet 1062 in the data area 23 of the accelerators 12. However, in reality, the TCP header is written in a TCP header portion 1071 in the TCP packet 1062′ in the I/O dedicated cache 14 (1052).

(4) In order to encrypt the TCP packet, CPU 11 activates the IPsec accelerator 12-2. In response, the IPsec accelerator 12-2 reads the TCP packet 1062 and writes an encrypted result in the IPsec data portion of an Ethernet frame 1063. In reality, however, 1062′ in the I/O dedicated cache 14 is read, and the encrypted data is written in the IPsec data portion of 1063′.

(5) CPU 11 creates a header portion (MAC header, IP header, and IPsec header) and writes it in the header portion of the Ethernet frame 1063 in the data area 23 of the accelerators 12. In reality, however, the header is written in a header portion 1072 of 1063′ in the I/O dedicated cache 14 (1053).

(6) CPU 11, in response to the completion of creation of the Ethernet frame 1063, sends a transmit request to the EtherMAC 12-3. In response, EtherMac 12-3 reads the Ethernet frame 1063 (in reality, 1063′ in the I/O dedicated cache 14) in the data area 23 of the accelerators 12 and outputs it to the Ethernet 3.

Thus, during the transmission processing too, the CPU 11 and the accelerators 12 can operate while unaware of the presence of the I/O dedicated cache 14.

Further, the I/O dedicated cache 14, because it is a cache, can be utilized without any problems even if a transmission processing and a reception processing take place simultaneously.

FIG. 28 shows a processing that is performed when the cache 110 in the CPU 11 has a snoop function.

In the above-described transmission processing (3), when the CPU 11 creates a TCP header when the cache 110 is valid and in a write-back mode, the actual TCP header exists only in the cache 110 and not in 1071 in the I/O dedicated cache 14 nor in the data area 23 of the accelerators 12. The IPsec accelerator 12-2, upon being activated by the CPU 11, attempts to read the TCP header. Upon detecting this access via the bus 13, the cache 14 issues an access interruption request to the IPsec accelerator 12-2 while it purges the data of the TCP header in the cache 110 to the TCP packet 1062 in the data area 23 of the accelerators 12. In reality, however, the TCP header data is written in the TCP header portion 1071 in the I/O dedicated cache 14.

When the purge processing is completed, the cache 110 cancels the access interruption request to the IPsec accelerator 12-2. In response, the IPsec accelerator 12-2 resumes the reading of the TCP header. Thus, it becomes possible to read the data of the correct TCP header 1071 after purge from the cache 110.

It should be noted here that by using the I/O dedicated cache 14 with short access time, and with reference to cache coherency between the cache 110 and the memory 2, the I/O dedicated cache 14 can be accessed without accessing the memory 2, which has a longer access waiting-time. Thus, it becomes possible to significantly reduce the overhead due to cache purge.

The present embodiment can provide the following effects:

(1) In accordance with the multimedia microprocessor 1 or 10 in which the I/O dedicated cache 14 is adopted, it is possible to minimize the bottleneck caused by data sharing during memory access when multimedia processing is performed by the CPU 11 and the accelerators 12 in a linked up fashion, thereby achieving enhanced multimedia processing performance.

(2) By noting the fact that the I/O dedicated cache 14 only stores data necessary for data sharing between the CPU 11 and the accelerators 12, and, that the determination as to whether or not data is to be stored in the I/O dedicated cache 14 is to be made only with regard to write-access to the memory 2, it becomes possible to improve the cache hit ratio in the I/O dedicated cache 14 during data sharing, so that the I/O dedicated cache 14 can be realized in a smaller size.

(3) Even when a plurality of accelerators 12 for multimedia applications are provided, data sharing can be performed with high efficiency. Therefore, the multimedia microprocessor 1 or 10 can process multimedia including voice, still images, and moving pictures, at high speed and efficiency. Also, a multimedia terminal 100 can be configured using such multimedia microprocessor.

While the invention has been particularly shown and described with reference to preferred embodiments thereof, it will be understood by those skilled in the art that various changes can be made without departing from the scope of the invention.

For example, while the foregoing embodiments has been based on wired communications capabilities using Ethernet, the invention is not limited to such embodiments and can also be applied to various other capabilities, such as: (1) wireless communications capability; (2) image display capability for graphics, MPEG, or JPEG (image compression/decompression); (3) camera processing capability enabling image processing such as image rotation and image quality adjustment; and (4) speaker processing capability for music, MP3 (voice compression/decompression), or the like.

While in the foregoing embodiments each configuration had a single CPU, the invention can be also effectively applied to configurations having a plurality of CPUs.

### INDUSTRIAL APPLICABILITY

As described above, the invention, which relates to a microprocessor, can be applied to microprocessors for communications and multimedia processing that are equipped with auxiliary circuits such as accelerators, in addition to the processing performed by the CPU.

### BRIEF DESCRIPTION OF THE DRAWINGS

FIG. 1 shows a diagram of a multimedia microprocessor according to an embodiment of the invention.

FIG. 2 shows a diagram of a memory in an embodiment of the invention.

FIG. 3 shows a diagram of another multimedia microprocessor in an embodiment of the invention.

FIG. 4 shows the flow of a multimedia processing in an embodiment of the invention.

FIG. 5 shows the flow of data (from preprocessing to an accelerator processing) in a multimedia processing in an embodiment of the invention.

FIG. 6 shows the flow of data (from the setting of a processed result to postprocessing) in an embodiment of the invention.

FIG. 7 shows a diagram of a bus in an embodiment of the invention.

FIG. 8 shows a diagram of an I/O dedicated cache in an embodiment of the invention.

FIG. 9 shows a diagram of a register in an embodiment of the invention.

FIGS. 10(a) and (b) shows register access paths in an I/O dedicated cache in an embodiment of the invention.

FIG. 11 shows the flow of a processing in a judgment circuit in an embodiment of the invention.

FIG. 12 shows a diagram of an address judgment circuit in an embodiment of the invention.

FIG. 13 shows a diagram of a cache in an embodiment of the invention.

FIG. 14 shows the operation of a cache in an embodiment of the invention.

FIG. 15 shows a diagram of a memory controller in an application of an embodiment of the invention.

FIG. 16 shows the structure of a cache in an application of an embodiment of the invention.

FIG. 17 shows the data structure of an access request in an application of an embodiment of the invention.

FIG. 18 shows a diagram of a multimedia terminal in which a multimedia microprocessor is used according to an embodiment of the invention.

FIG. 19 shows a diagram of another multimedia microprocessor in an embodiment of the invention.

FIG. 20 shows how a cache and an I/O dedicated cache are used separately in an embodiment of the invention.

FIG. 21 shows a diagram of a specific multimedia microprocessor in an embodiment of the invention.

FIG. 22 shows a frame structure for communications purposes in an embodiment of the invention.

FIG. 23 shows another frame structure for communications purposes in an embodiment of the invention.

FIG. 24 shows the operation of a cache in an embodiment of the invention (reception processing involving no I/O dedicated cache).

FIG. 25 shows the operation of a cache in an embodiment of the invention (reception processing involving an I/O dedicated cache).

FIG. 26 shows the operation of a cache in an embodiment of the invention (reception processing involving an I/O dedicated cache in which a shared data portion alone is stored).

FIG. 27 shows a processing for transmitting encrypted data in an embodiment of the invention.

FIG. 28 shows the operation of a cache in an embodiment of the invention (involving a snoop function).

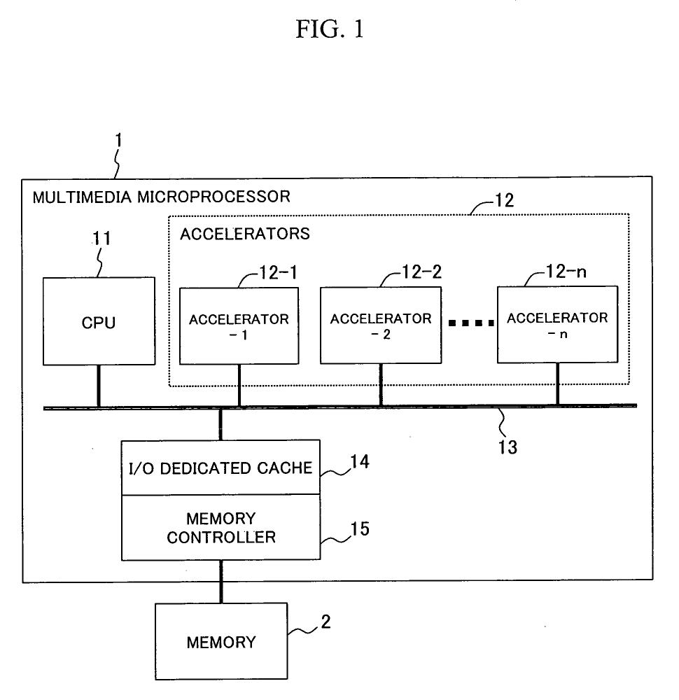

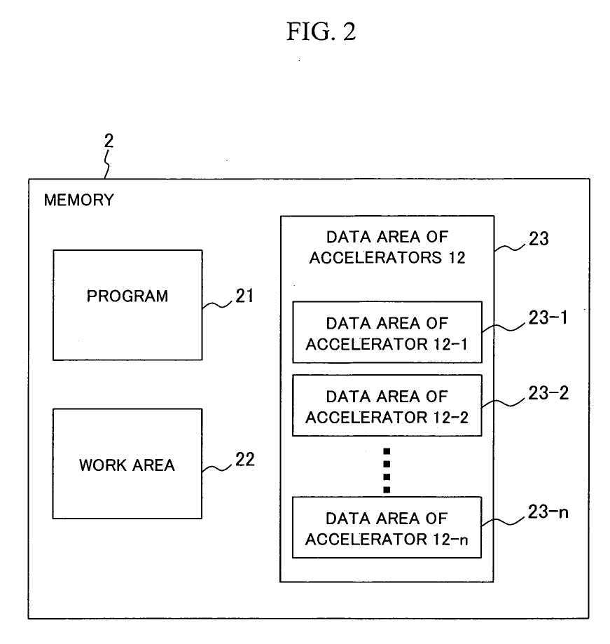

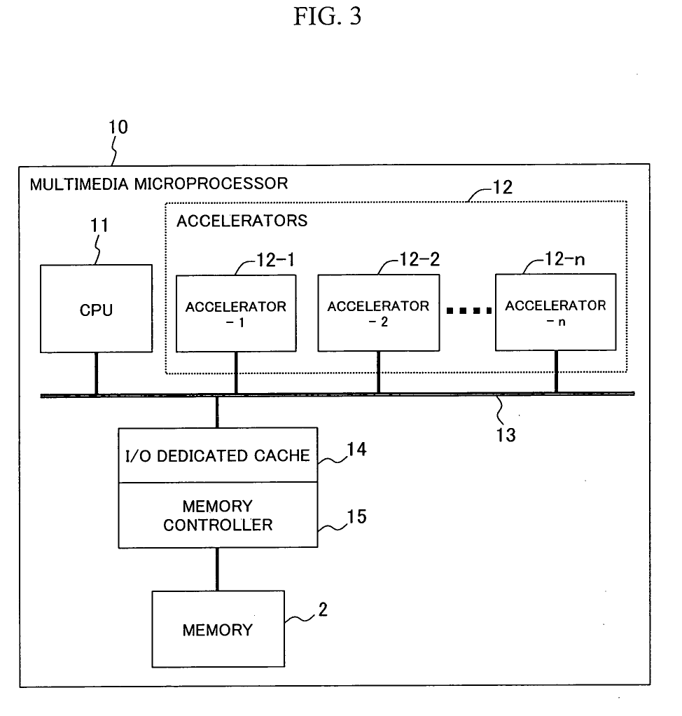

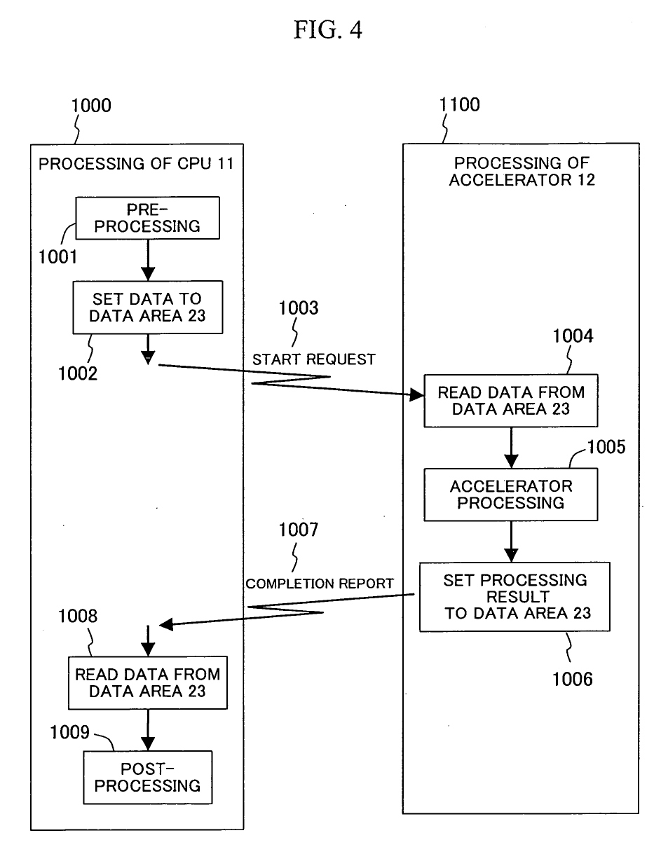

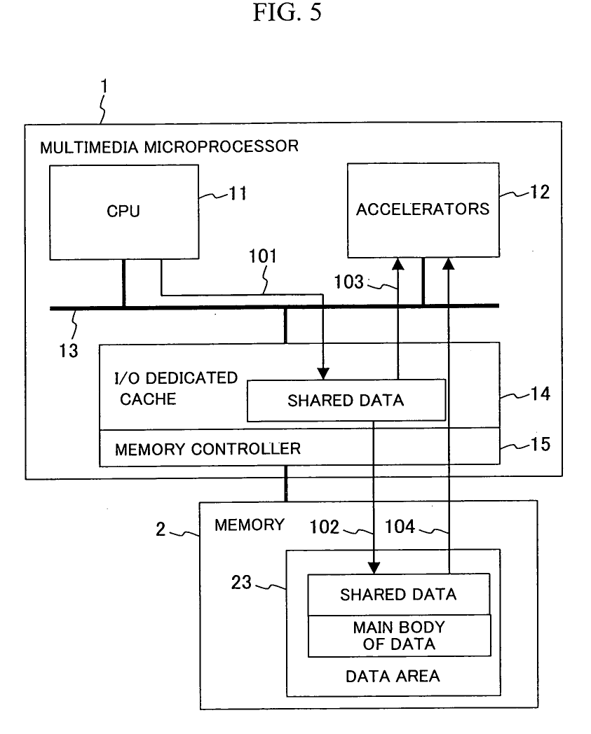

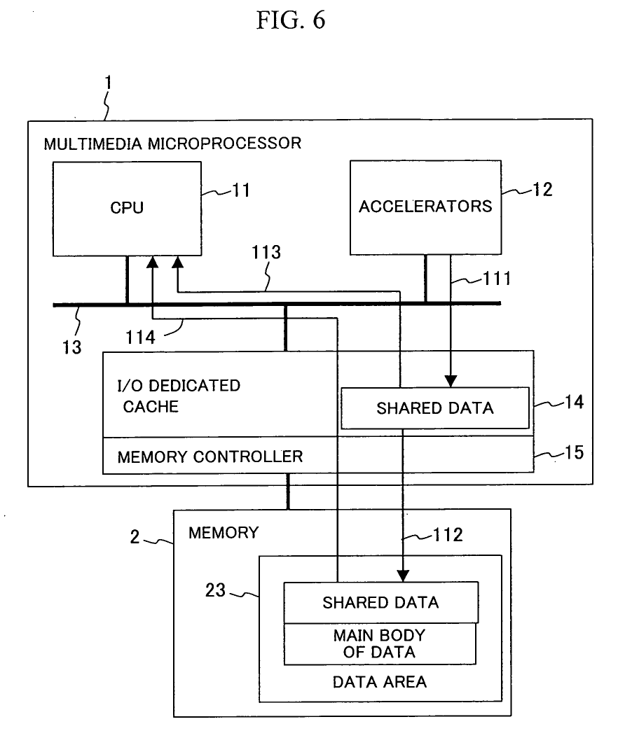

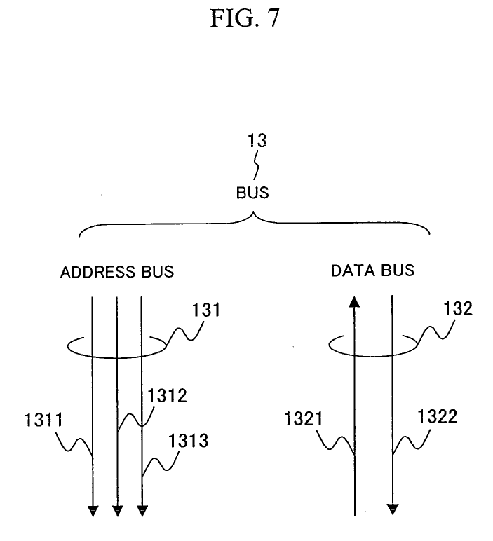

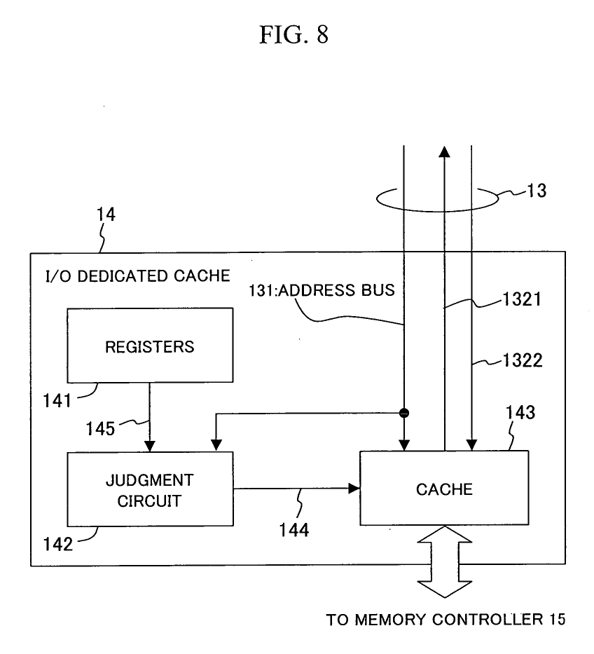

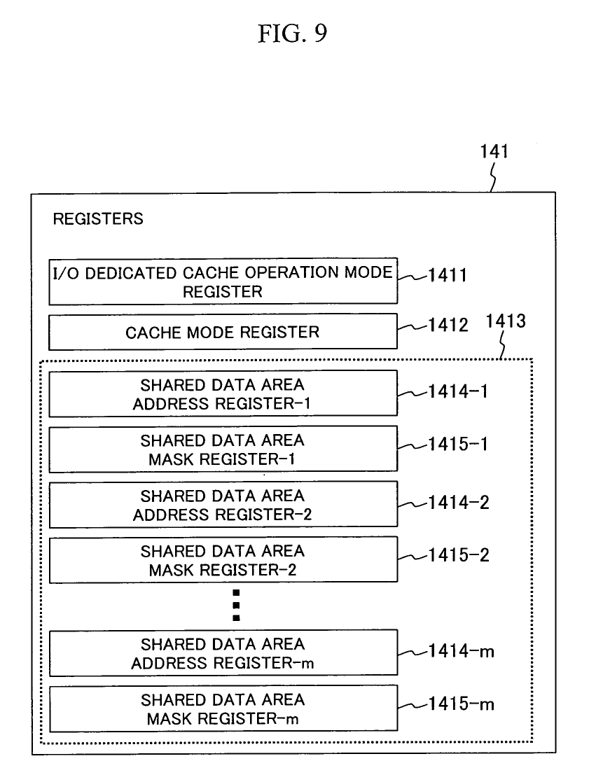

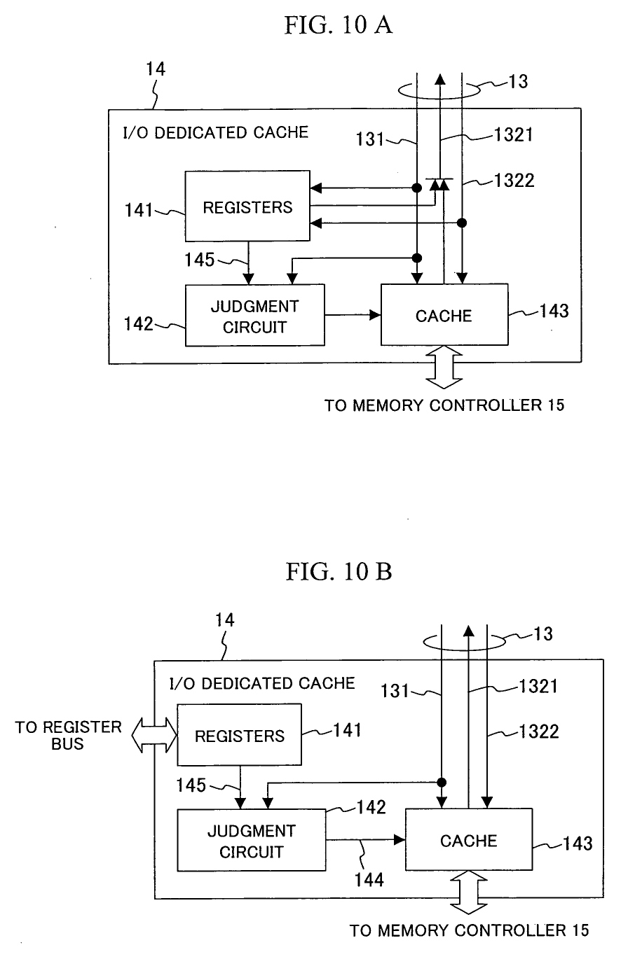

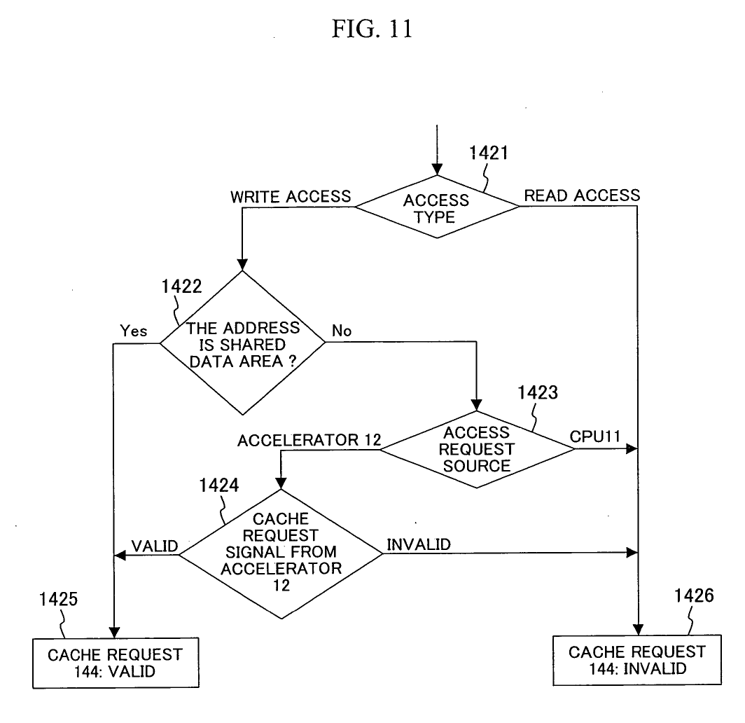

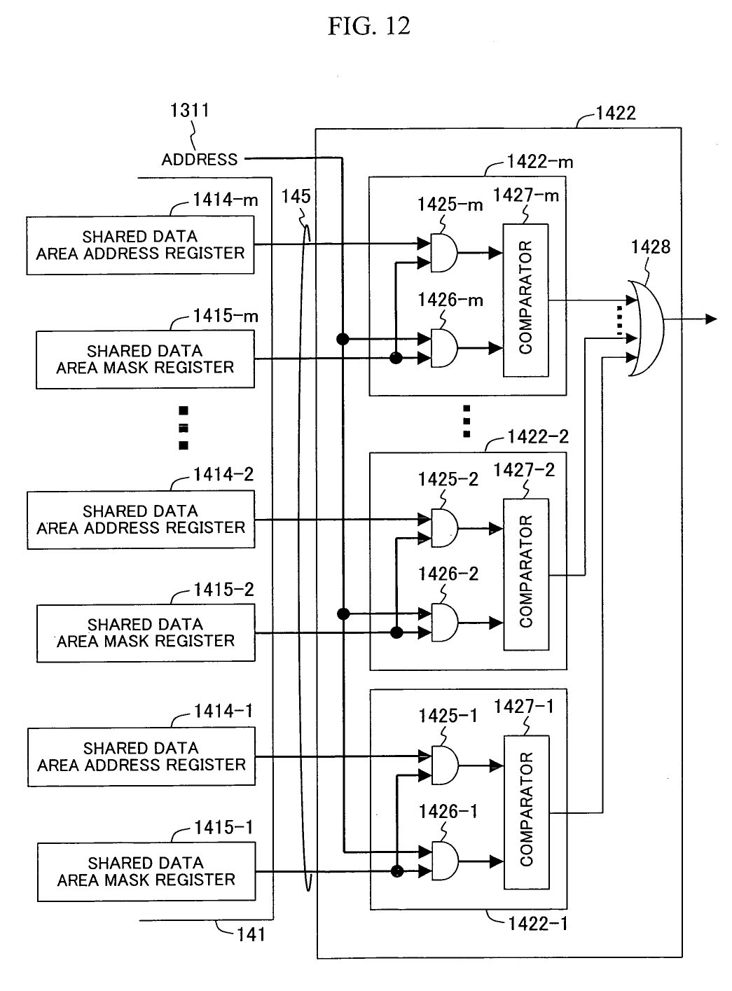

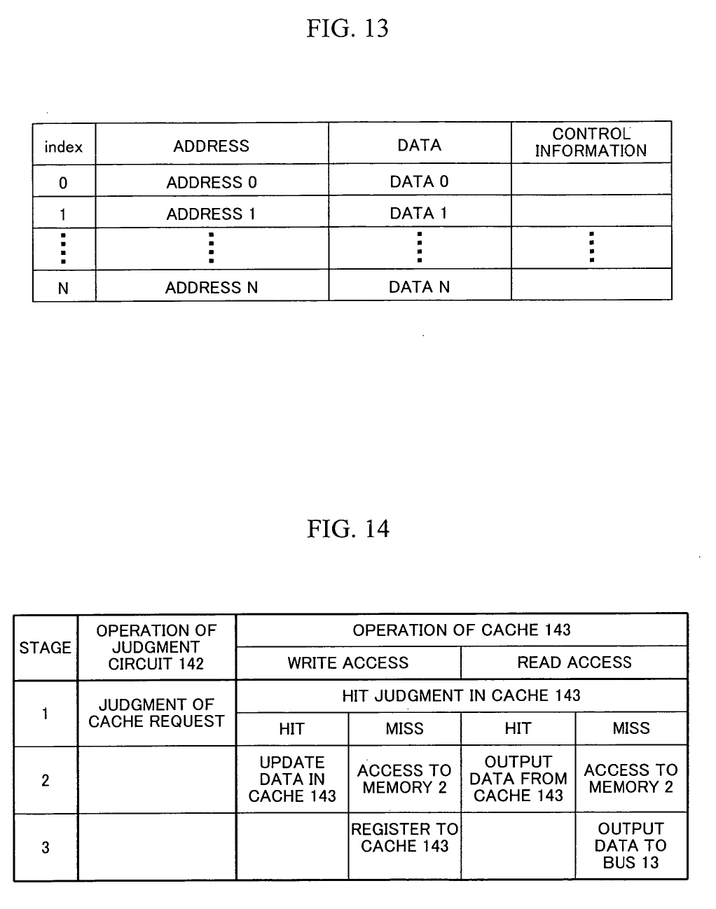

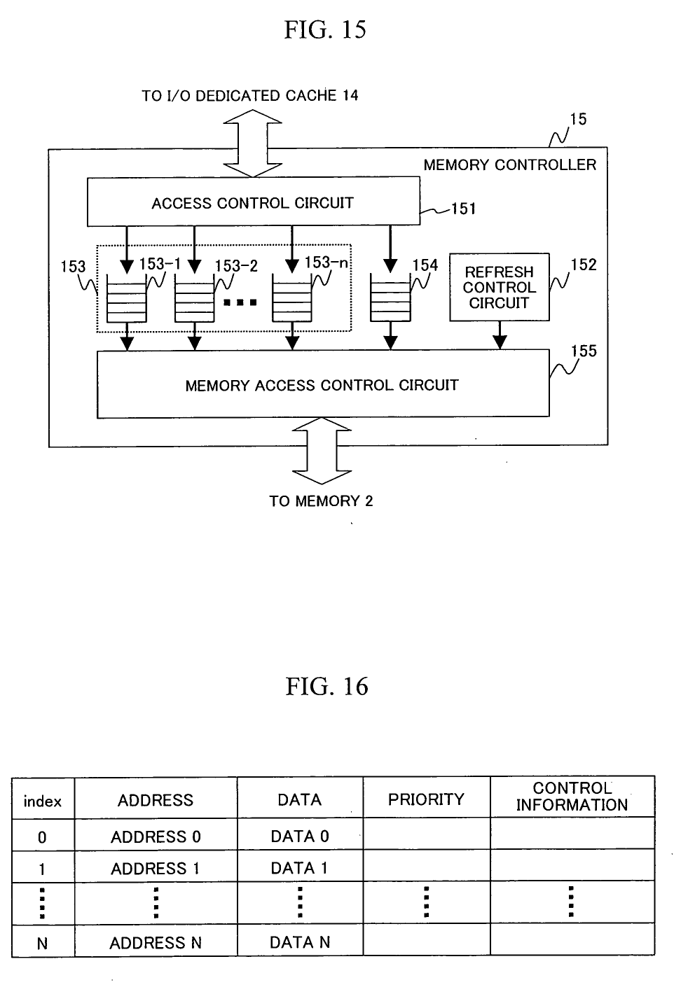

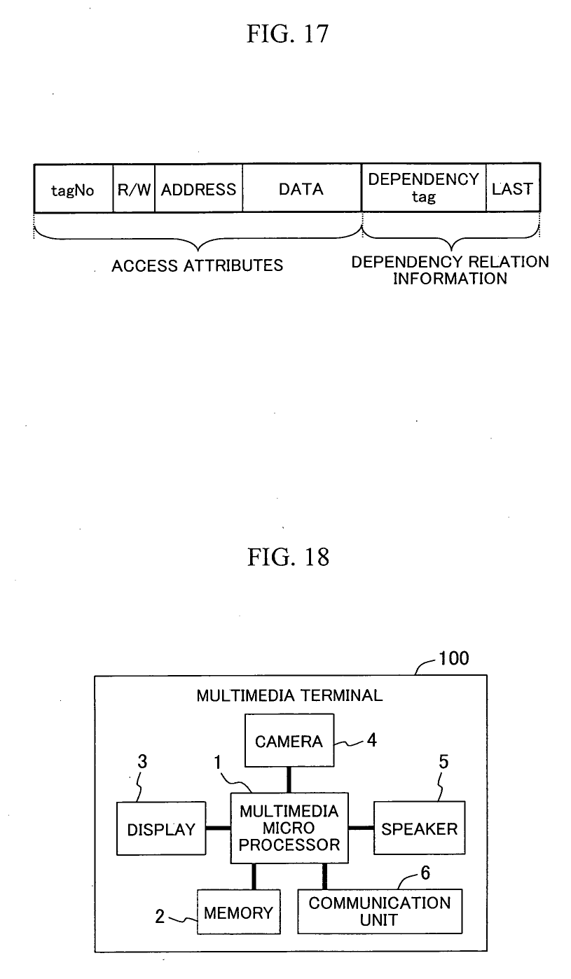

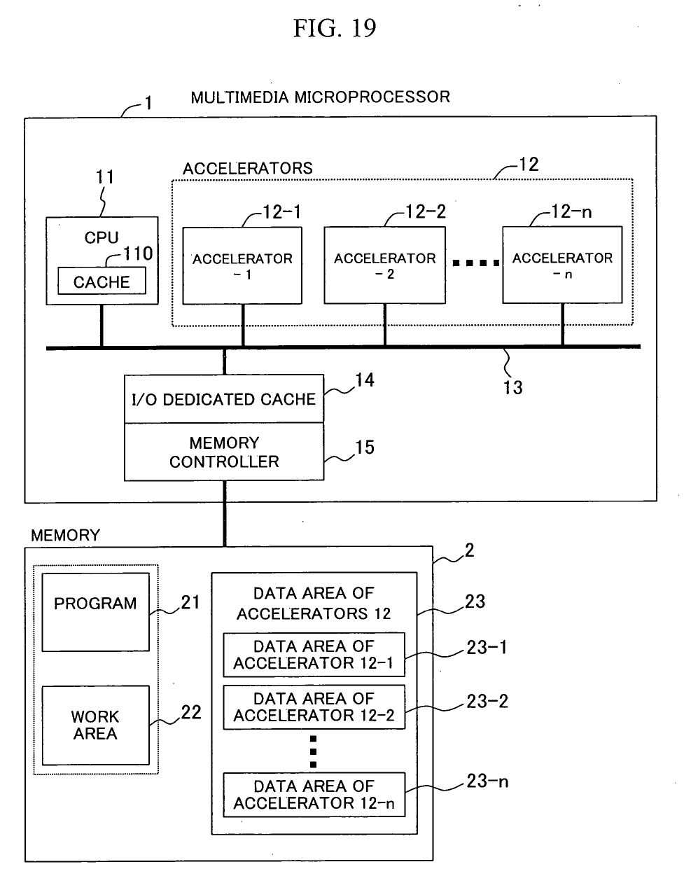

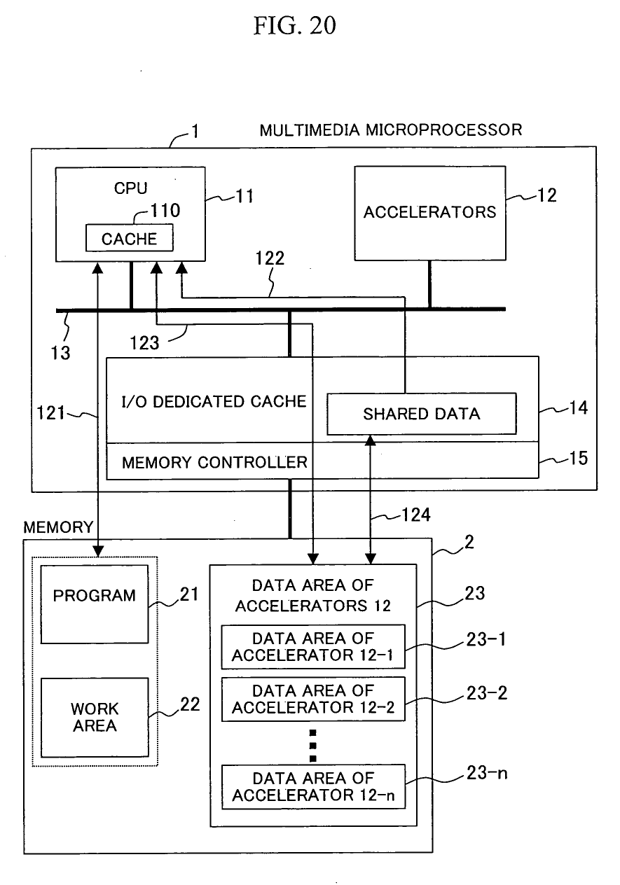

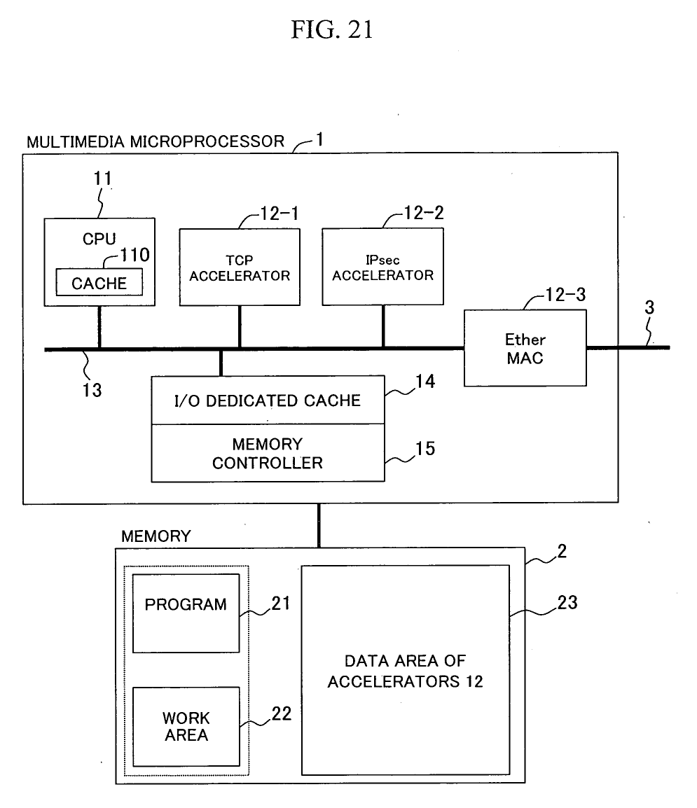

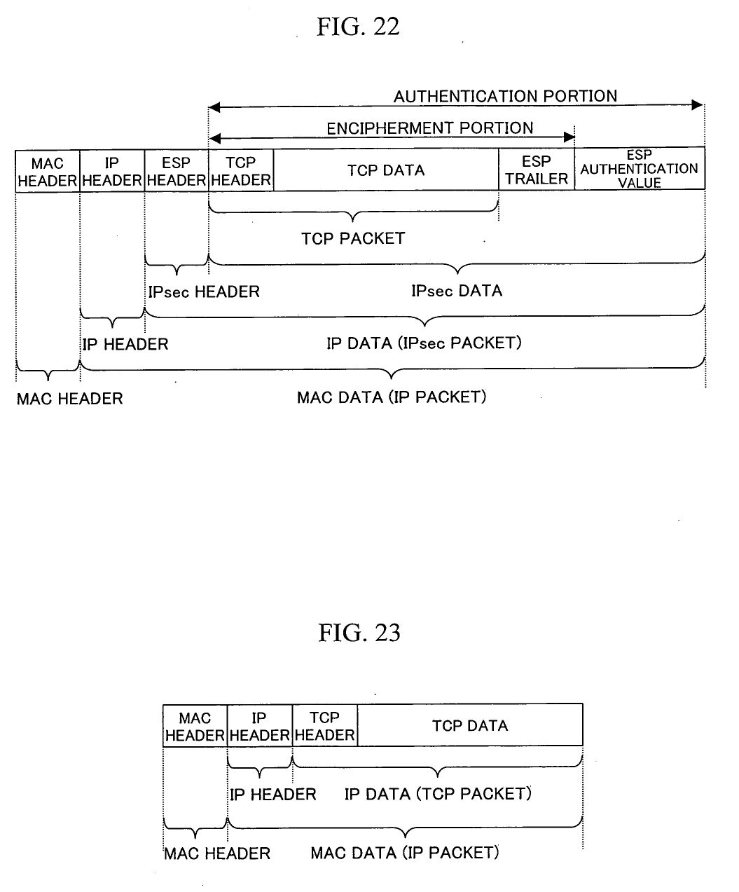

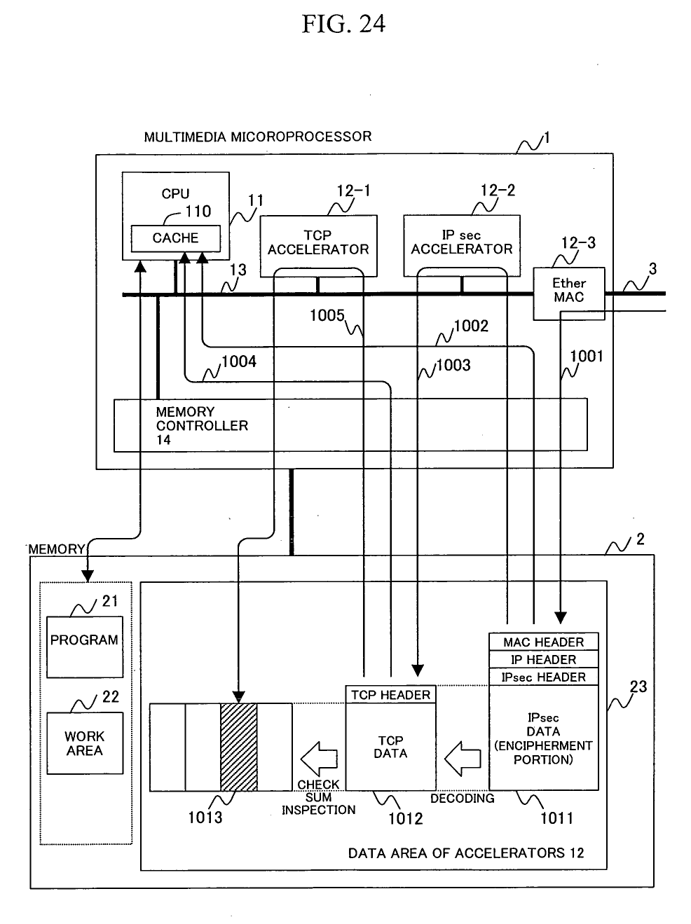

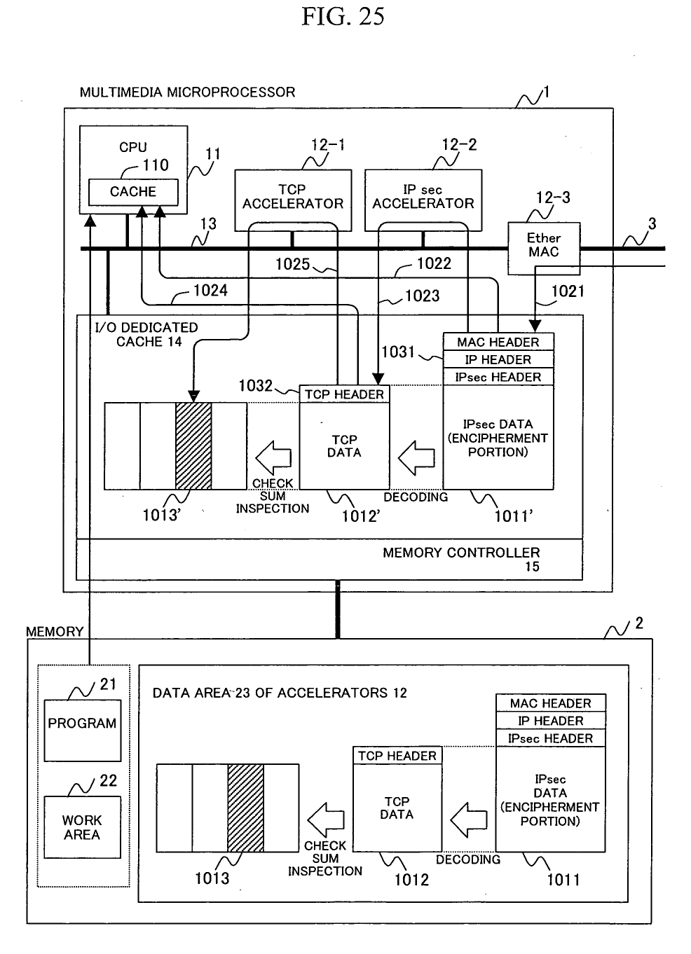

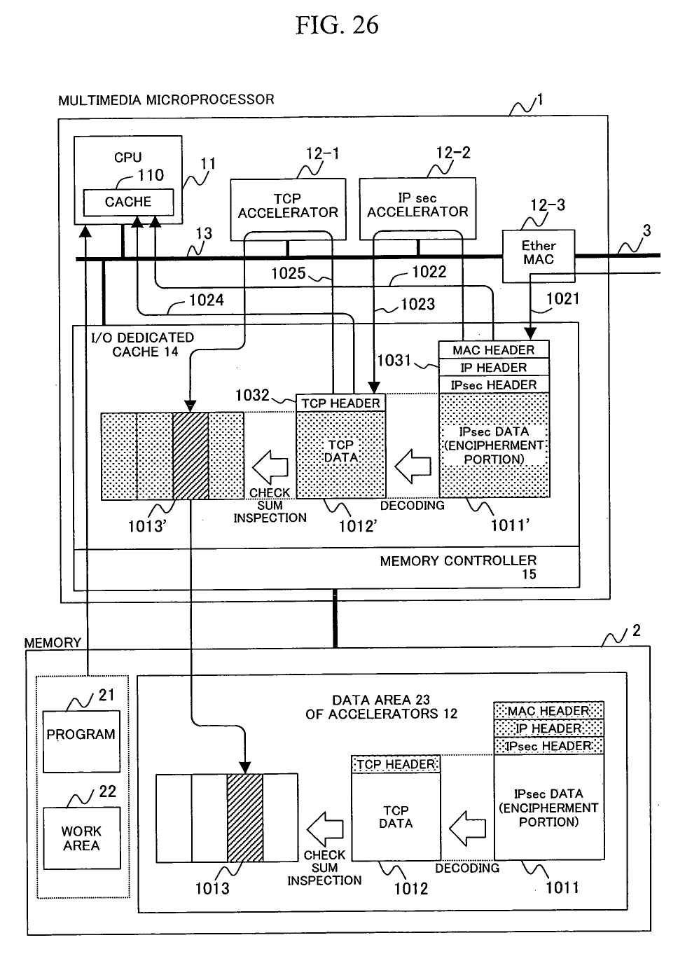

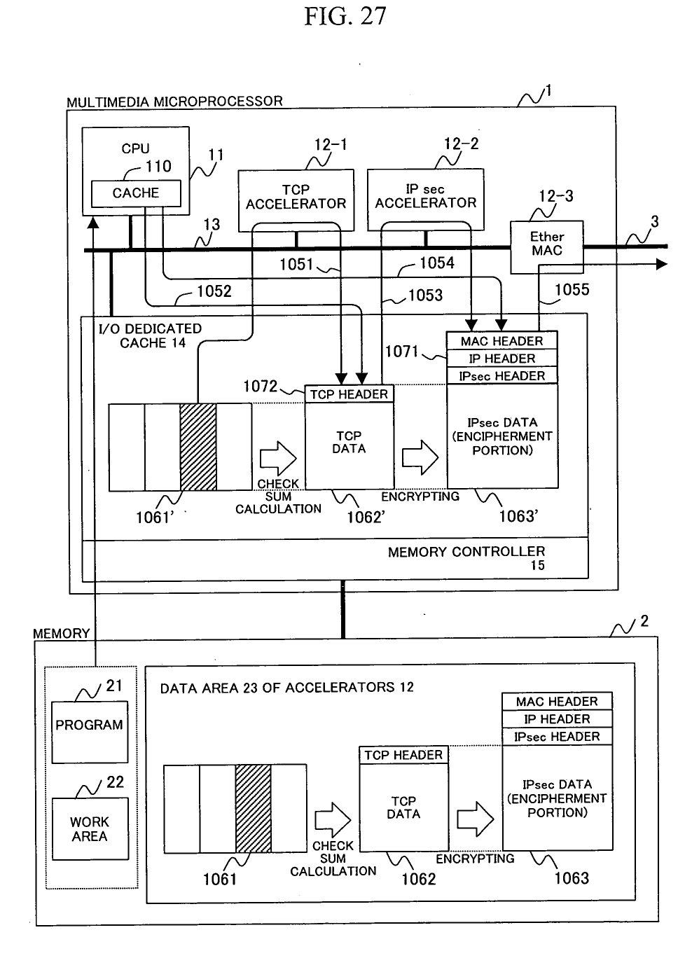

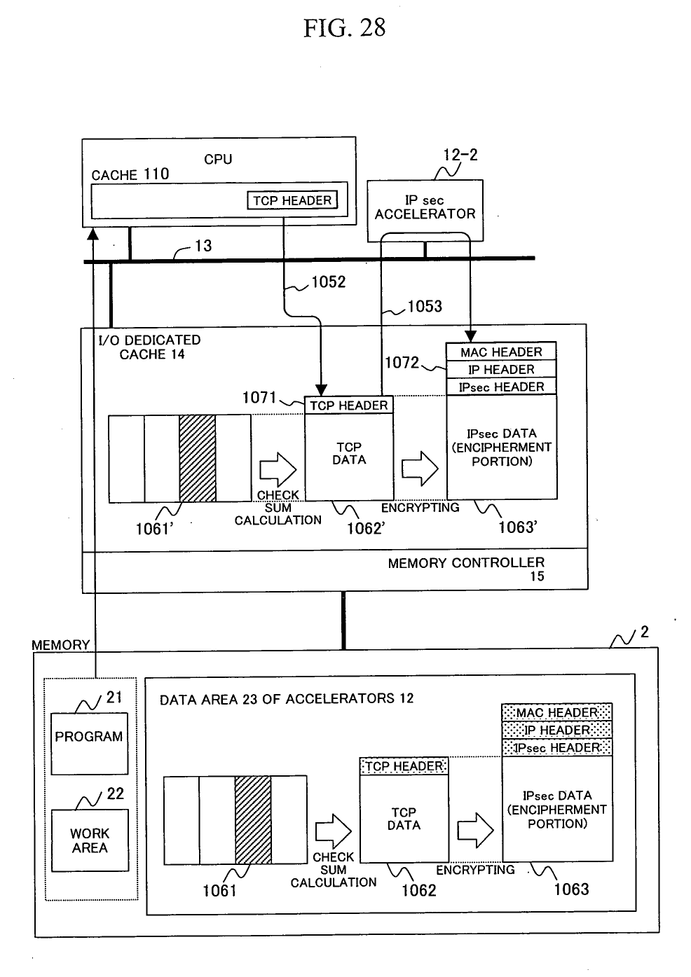

### DESCRIPTION OF REFERENCE NUMERALS

1 . . . Multimedia microprocessor, 2 . . . Memory, 3 . . . Display, 4 . . . Camera, 5 . . . Speaker, 6 . . . Communications unit, 10 . . . Multimedia microprocessor, 11 . . . CPU, 12 . . . Accelerators, 13 . . . Bus, 14 . . . I/O dedicated cache, 15 . . . Memory controller, 21 . . . Program, 22 . . . Work area, 23 . . . Data area, 100 . . . Multimedia terminal, 110 . . . Cache, 141 . . . Registers, 142 . . . Judgment circuit, 143 . . . Cache, 151 . . . Access control circuit, 152 . . . Refresh control circuit, 153 . . . Read access request FIFO, 154 . . . Write access request FIFO, 155 . . . Memory access control circuit

1. A microprocessor comprising:
a CPU operating as a master; and
a plurality of accelerators operating as slaves, wherein said CPU and said accelerators can access a memory, and wherein data for which said CPU and said accelerators access said memory is comprised of first data that is exchanged between said CPU and said accelerators and the remaining, second data,
said microprocessor further comprising a cache means for storing said first data out of said first data and said second data.

2. The microprocessor according to claim 1, wherein, when said CPU and said accelerators output requests for write-accessing said memory, said cache means determines whether or not to store data regarding said write access requests.

3. The microprocessor according to claim 2, wherein said accelerators issue storage requests to said cache means when write-accessing said memory.

4. The microprocessor according to claim 3, wherein said cache means determines whether or not to store data outputted from said accelerators in response to storage requests that are outputted when said accelerators write-access said memory.

5. The microprocessor according to claim 2, wherein said cache means determines whether or not to store said data depending on an address outputted from said CPU and said accelerators when said CPU and said accelerators write-access said memory.

6. The microprocessor according to claim 1, wherein said cache means outputs said data to said accelerators if, when said accelerators issue requests for read-accessing said memory, said cache means has the data regarding said read access requests stored therein.

7. The microprocessor according to claim 1, further comprising a memory controller for controlling access from said CPU and said accelerators to said memory,
wherein access requests from said CPU and said accelerators are prioritized, wherein said memory controller processes access requests from said CPU and said accelerators in accordance with the order of priority.

8. The microprocessor according to claim 7, wherein said memory is comprised of a SDRAM or a DDR-SDRAM, and wherein said memory controller processes access requests from said CPU and said accelerators such that locations of the same row address in the same bank in said memory are accessed sequentially.

9. The microprocessor according to claim 8, wherein said memory controller manages a dependency relation with regard to those of access requests from said CPU and said accelerators that are addressed to the same address location such that access consistency with respect to said memory can be maintained.

10. The microprocessor according to claim 1, wherein said memory is provided outside said microprocessor.

11. The microprocessor according to claim 1, wherein said memory is provided inside said microprocessor.

12. The microprocessor according to claim 1, wherein said CPU has an internal cache.

13. The microprocessor according to claim 12, wherein said microprocessor is connected to an external memory in which a program area or a work area is formed.

14. The microprocessor according to claim 13, wherein said external memory has a data area for said accelerators formed therein.

15. The microprocessor according to claim 12, wherein said internal cache of said CPU has a snoop function.
